(19) United States
(12) Patent Application Publication
(10) Pub. No.: US 2014/0245196 A1
(43) Pub. Date: Aug. 28, 2014

(54) USER INTERFACE GENERATION AND PREVIEW

(71) Applicant: Google Inc., Mountain View, CA (US)

(72) Inventors: Wentao Zheng, Jersey City, NJ (US); Daniel Lee, New York, NY (US); Adam Michaeli, Tel Aviv (IL)

(73) Assignee: Google Inc., Mountain View, CA (US)

(21) Appl. No.: 13/963,834

(22) Filed: Aug. 9, 2013

(30) Foreign Application Priority Data
Feb. 26, 2013 (IL) 224936

(51) Int. Cl. G06F 3/0484

(52) U.S. Cl. CPC G06F 3/0484
USPC 715/762

(57) ABSTRACT

User interface features for a user interface may be selected or generated based on introspection of a template. A template, such as a content item template, may include an annotation identifying a portion for which a user interface feature is to be generated. Introspection of the content item template may include determining the APIs used, the defined data types, the instantiated data objects, and/or the annotations of the template. Based on the determination, a data tree may be determined for the template. User interface features may be generated based on the values of the data tree. A user interface may be created based on the generated user interface features. In some instances, a preview of the content item may be included with the user interface. The preview may be updated as values are modified for the user interface.

### PRIORITY

The present disclosure claims foreign priority to Israeli Patent Application No. 224,936, entitled “USER INTERFACE GENERATION AND PREVIEW,” filed Feb. 26, 2013, the entirety of which is hereby incorporated by reference.

### BACKGROUND

In a networked environment, such as the Internet or other networks, first-party content providers can provide information for public presentation on resources, for example web pages, documents, applications, and/or other resources. The first-party content can include text, video, and/or audio information provided by the first-party providers via, for example, a content server for presentation on the Internet. Additional third-party content can also be provided by third-party content providers for presentation on the resources together with the first-party content provided by the first-party providers. Thus, a person viewing a resource can access the information that is the subject of the resource, as well as the third-party content that may or may not be related to the subject matter of the resource.

### SUMMARY

One implementation relates to a method for generating a user interface. The method may include receiving a template for creating a content item that includes an annotation. The data types and the data objects for the received template may be determined. A data tree may be determined based on the determined data types and the data objects. A user interface feature may be generated based on the data tree and the annotation. The user interface feature may include a base user interface feature for a basic value of the data tree and an appendable user interface feature for an appendable value of the data tree. Data to effect presentation of the user interface based on the generated user interface feature may be outputted.

Another implementation relates to a system for creating a content item based on a content item template. The system may include a data processor and a computer readable storage device having instructions that, when executed by the data processor, cause the data processor to perform several operations. The operations may include receiving a template for creating a content item that has an annotation. The data types and the data objects of the received template may be determined. A user interface feature for the template may be generated based on the annotation and one of a data type or a data object. Data to effect presentation of the user interface based on the generated user interface feature may be outputted. An input associated with a data object may be received. Data to effect presentation of a preview content item based on the received input and the template may be outputted.

Still another implementation relates to a computer readable storage device having instructions to provide information via a computer network. The instructions may include instructions to receive a template for creating a content item and having an annotation. The data types and the data objects of the received template may be determined. A data tree for the template may be determined based on the data types and the data objects. A user interface feature for the template may be generated based on the data tree and the annotation. The user interface feature may include a base user interface feature for a basic value of the data tree, an appendable user interface feature for an appendable value of the data tree, and a composite user interface feature for a composite value of the data tree.

### BRIEF DESCRIPTION OF THE DRAWINGS

Various implementations taught herein are illustrated by way of example, and not by way of limitation, in the figures of the accompanying drawings, in which:

FIG. 1 is an overview depicting an example system of providing information via a computer network;

FIG. 2 is an overview of a content item system having a content item template database;

FIG. 3 is a diagram of an example method of generating a content item using a content item template;

FIG. 4 is a flow diagram of an example method of generating user interface features based on a content item template;

FIG. 5 is an overview of an example content item template;

FIG. 6 is an overview of an example data tree for a content item template;

FIG. 7 is a diagram of an example method of generating a user interface and a preview content item based on a content item template;

FIG. 8 is an overview of an example user interface and an example preview content item; and

FIG. 9 is a block diagram illustrating a general architecture for a computer system that may be employed to implement various elements of the systems and methods described and illustrated herein.

It will be recognized that some or all of the figures are schematic representations for purposes of illustration. The figures are provided for the purpose of illustrating one or more implementations with the explicit understanding that they will not be used to limit the scope or the meaning of the claims.

### DETAILED DESCRIPTION

Following below are more detailed descriptions of various concepts related to, and implementations of, methods, apparatuses, and systems for providing information on a computer network. The various aspects discussed in greater detail below may be implemented in any of numerous ways, as the described aspects are not limited to any particular manner of implementation. Examples of specific implementations and applications are provided primarily for illustrative purposes.

Templates may be used for a wide variety of purposes, such as the creation of applications, resources (e.g., web pages), content items, etc. To further improve usability of the template, a user interface may be utilized such that the customization of the template may be simplified. For example, an integrated development environment may be utilized to build a user interface for a template by manually adding predefined features, such as widgets, to create the user interface. In other instances, the template may be provided with a pre-created user interface and/or pre-created user interface features (i.e., filler or widgets) for a user interface to customize the template. In both instances, time and effort may be needed to generate such features for the user interface for the template. Accordingly, it may be useful to provide the ability to automatically generate the user interface features for the user interface for the template.

In some implementations, a template may be used during the creation of a content item. A content item may be provided with a resource for presentation on a display of a requesting device. For example, a third-party content item, such as an advertisement, may be presented with a resource, such as a web page, which may allow a user viewing the resource to select the third-party content item and be directed to the subject matter related to the third-party content item. Such content items may be created by third-party content providers for a variety of products, services, etc. In some implementations, it may save time, cost, and/or effort to utilize a template when creating the third-party content items. In other instances, the use of a template may be useful to create a portfolio of third-party content items that are substantially similar in size, shape, and/or appearance.

To further simplify the creation of the content items, a user interface for the template may be provided such that the creator of the content item may modify the customizable portions of the template in a quick and efficient manner. As noted above, it may be useful to automatically generate the user interface for the template. In one example, introspection of the template may be performed to determine the data types, data objects, and/or hierarchies of the template. Such introspection may be used to determine or generate a customizable data tree. Various user interface features, such as filler or widgets, may be selected for each portion of the data tree and a user interface may be generated based on the selected user interface features. In some implementations, an annotation may be used to define the customizable portions of the template. Such an annotation may be an independent identifier to support data structures across different domains or different programming languages. In further implementations, user interface tuning algorithms may be applied to the generated user interface to improve the visual appearance, layout, and/or otherwise.

In some instances, a preview of the content item may be provided with the user interface such that a creator of the content item may view the effects of the modifications to the customizable features of the template. Updating the preview of the content item automatically (i.e., a live update) may be useful to provide substantially immediate visual feedback regarding the changes to the content item. That is, a creator of the content item may see the effects of their changes immediately. In one implementation, when a data value is changed within the user interface, the data value may be used to regenerate the preview of the content item from the template. For example, a data binding API may be used with annotations of the template to determine which data values are updatable such that changes to the data values may be observed and used in updating the preview of the content item. In some implementations, the selection of a feature of the user interface may cause a portion of the preview to be highlighted such that the user can identify the portion being modified. In some cases, a feature of the user interface may be associated with a frame of a multi-frame content item. For example, a content item may cycle through various images when being presented. During the creation of the content item, when the feature of the user interface associated with that frame is selected, the preview may be updated to show that specific frame.

Of course, while the foregoing has described user interfaces and previews relative to content items, it should be understood that such user interfaces and previews may be used with other generated objects or items.

I. Overview of Example System

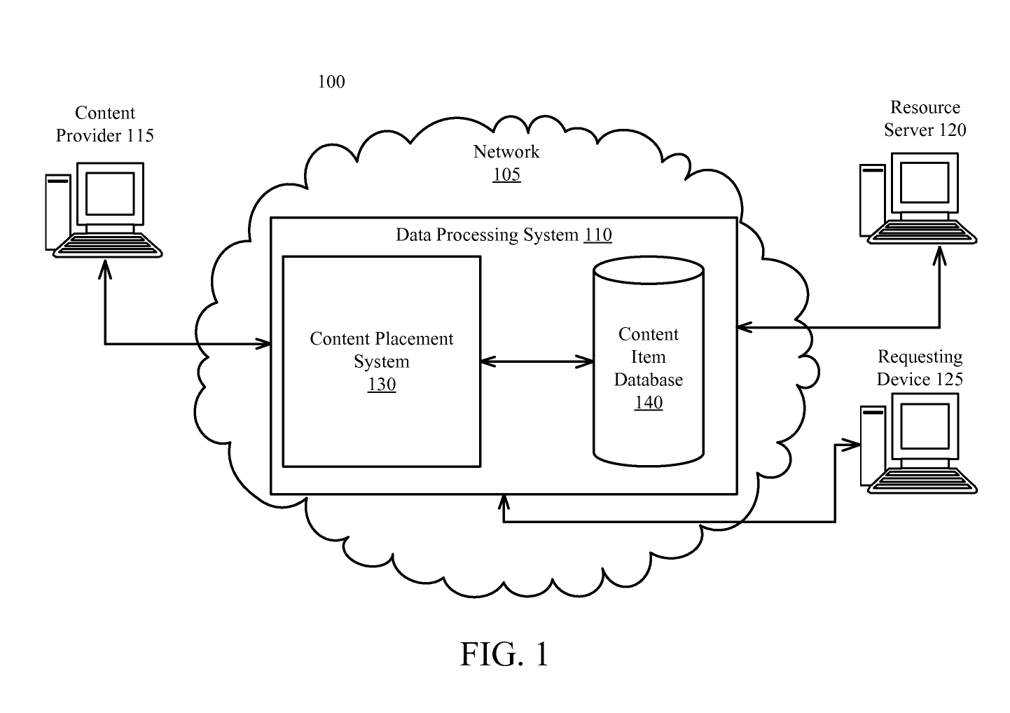

FIG. 1 illustrates an example system 100 for providing information via a computer network such as the network 105. The network 105 can include computer networks such as the Internet, local, wide, metro or other area networks, intranets, and other computer networks such as voice or data mobile phone communication networks. The system 100 can also include a data processing system 110. The data processing system 110 can include a logic device, such as a computing device, having a processor to communicate via the network 105, for example with a resource server 120, a requesting device 125, and a third-party content provider 115. The data processing system 110 can include one or more data processing systems, such as the content placement system 130 configured to process information and provide content to the resource server 120 or the requesting device 125, and one or more databases, such as the content item database 140 configured to store information, such as content items. The data processing system 110 can include a server, such as an advertisement server.

The requesting device 125 can include computing devices such as a computer, laptop, desktop, smart phone, tablet, personal digital assistant, or server device configured to communicate with other devices via the network 105. The requesting device 125 can execute a software application (e.g., a web browser or other application) to retrieve content from other computing devices over network 105.

The resource server 120 can include a computer having a server configured to host a resource, such as a web page or other resource. For example, the resource server 120 may be a computer server (e.g., an FTP server, file sharing server, web server, etc.) or a combination of servers (e.g., a data center, a cloud computing platform, etc.). The resource server 120 can provide resource data or other content (e.g., text documents, PDF files, and other forms of electronic documents) to the requesting device 125. In one implementation, the requesting device 125 can access the resource server 120 via the network 105 to request access to a resource of the resource server 120.

In one implementation, the data processing system 110 can receive, via the network 105, a request for a content item to present with a resource. In one implementation, the resource includes a web page. The resource may include a content item slot, such as a designated location of the resource, for presentation of one or more third-party content items. The content placement processor 130 can be configured to receive a request from the resource server 120 or the requesting device 125 and select a content item from the content item database 140 such that data to effect presentation of the content item may be sent to the resource server 120 and/or the requesting device 125. The resource server 120 may include a first party provider of a resource, who may have an agreement with the data processing system 110 for the system to provide content items to present with one or more resources of the resource server 120. The requesting device 125 may be a computing device operated by a user (represented by a device identifier), which, when accessing a resource of the resource server 120, can make a request to the data processing system 110 for content to be presented with the resource, for instance.

II. Example Content Item System

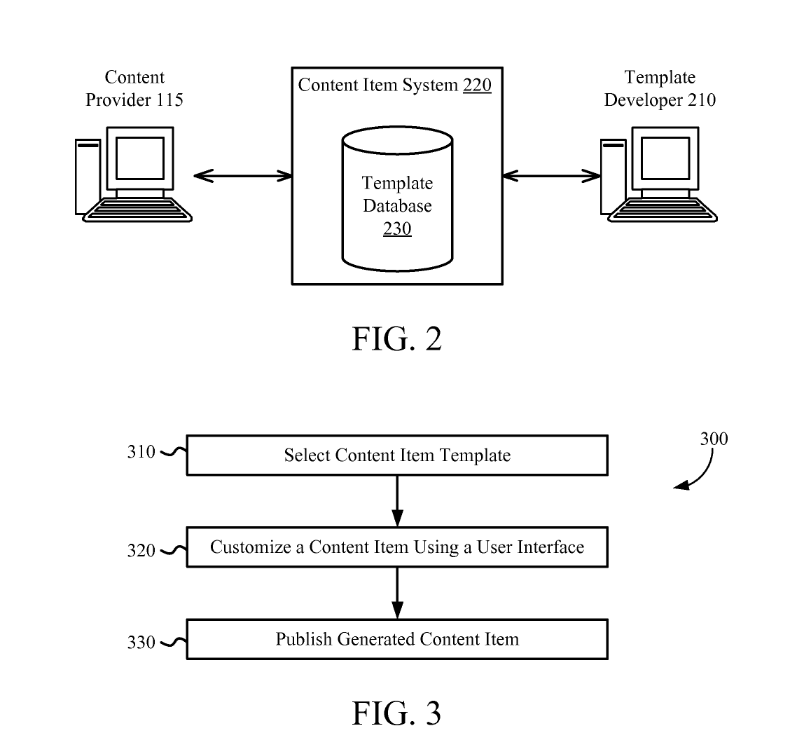

In some instances, the creation of content items for the content item database 140 may utilize one or more templates to generate the content items. For example, as shown in FIG. 2, a template developer 210 may create a content item template, described in greater detail below, to be transmitted to a content item system 220 and stored in a template database 230. In some instances, the content item system 220 may be combined or otherwise associated with the data processing system 110 or the content item system 220 may be independent of the data processing system 110. The template database 230 may contain several content item templates that may be selected and used in the creation of a content item. In some instances, the template database 230 may be accessible over a network, such as the internet, to retrieve and use content item templates from the template database 230. A creator of a content item, such as the content provider 115, may access the content item system 220 and select a content item template from the template database 230 from which to generate a content item. In some instances, the content item system 220 may be a local application on a computing device for the creator of the content item. In some other instances, the content item system 220 may be a remote system that may be accessible via a network, such as the internet, so that the creator of the content item may access the content item system 220 remotely. In one example, the content item system 220 may remotely accessible via a web service.

FIG. 3 depicts an example method 300 that a creator of a content item may use for generating the content item from a content item template. The creator may select a content item template (block 310). As noted above, the content item template may be stored in the template database 230 of a content item system 220. Several templates may be stored on the template database 230 such that the creator may have a variety of templates to select from. In some instances, the selection of a content item template from the content item database 230 may cause the content item system 220 to transmit data for the content item template, user interface features, and/or a user interface to the computing device of the content provider 115 or other creator of a content item using the content item template.

The selection of the content item template may be performed by selecting an icon, link, image, and/or other representation of the content item template on a resource, such as a web page, having one or more content item templates. In other instances, the selection of the content item template may be performed by selecting a file, either locally stored or remotely stored, for the content item template.

The creator may customize a content item using a user interface for the content item template (block 320). For example, the creator may interact with various features of the user interface to select and/or provide data values for a background color, a background image, textual content, various content media (e.g., images, video, audio, etc.), social media links, resource links, navigational controls, layout configurations, display configurations, timing configurations, events, etc. of the content item template. Such user interface features may be provided as a group or individually. For example, the user interface may include all the user interface features in a single presentation, such as on a single web page and/or frame of a web page, so that the creator may select and/or provide data values for the various customizable features of the content item template at once. In another example, the user interface features may be grouped, such as by type (images, text, links, etc.), by category (background, main content, secondary content, etc.), by sequence (first frame, second frame, etc.), and/or by any other manner. In still another example, the user interface features may be presented individually, such as in a sequential manner, so the creator may select and/or provide data values for each aspect of the content item template being modified.

As will be discussed in greater detail below, a preview of the customized content item from the content item template may be presented with the user interface such that the creator may preview the content item on demand (e.g., in response to a selection of a “Preview” button) and/or as data values of the user interface are changed, such as a live update.

The creator may then finalize or publish the generated content item (block 330). For instance, the data values entered into the user interface features of the user interface may be used to modify the content item template to create a file for the customized content item. For example, if data values and/or selections are made using user interface features of a user interface provided as a web service, the user may select a “Save” and/or “Publish” button to transmit the data values and/or selections to the content item system 220. The content item system 220 may then modify the content item template by inserting the data values and/or data for the selections into the corresponding portions of the code of the content item template to generate the customized content item. In the instance of a local application, the application may insert the data values and/or data for the selections into the corresponding portions of the code of a locally stored content item template to generate the customized content item. The generated content item may be saved to a data storage device locally and/or remotely for the creator to later use. In some instances, the generated content item may be transmitted to another computing device, such as the content placement system 130 to be stored in a content item database 140 for use in selection and serving of content items.

While the foregoing generally describes a system and method for generating a content item using a content item template, in some instances it may be useful to generate the various user interface features for the user interface automatically based on the content item template. Accordingly, the user interface features may be used to populate a user interface template when presenting the user interface for a creator of a content item to modify the content item template. In addition, in some instances it may be useful to provide a system that can utilize one or more annotations of the content item template to generate the user interface features. Annotations can include tags, predefined methods, predefined variables, and/or other predefined language constructs. Thus, a template developer may simply add the annotations to the relevant portions of their code to enable the system to automatically generate the user interface features. Such annotations may also allow a template developer to add annotations to existing content item templates such that the system can generate the user interface features for the existing content item templates.

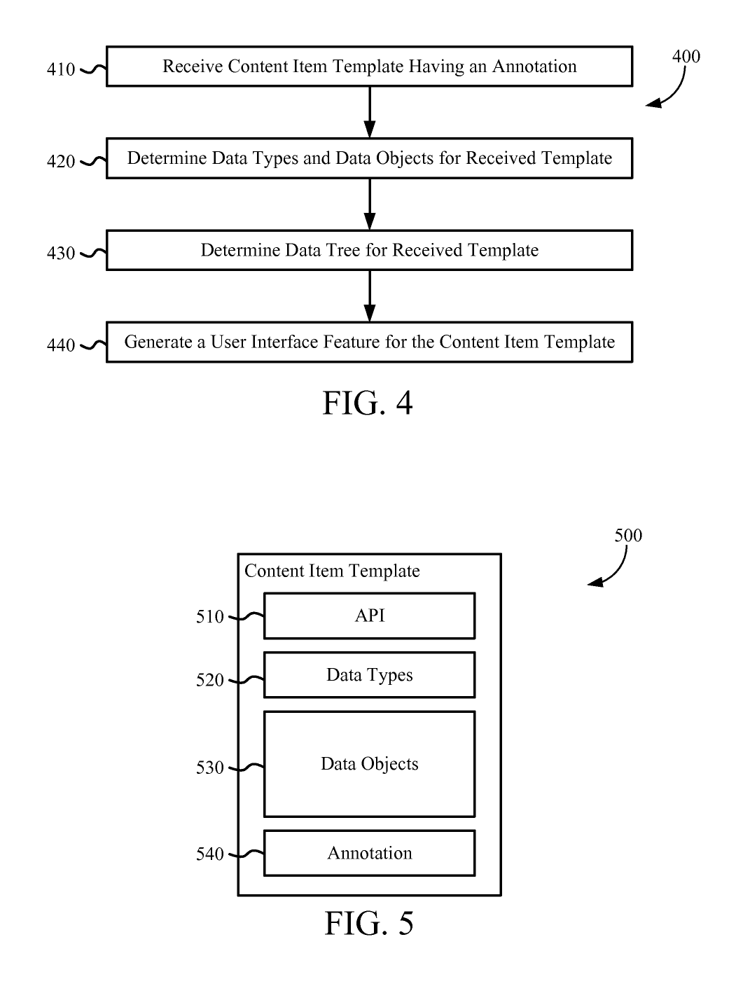

FIG. 4 depicts an example method 400 for generating a user interface feature based on a content item template. Such a method may be implemented via content item system 220, a content provider 115, a template developer 210, and/or by any other system. The method may be implemented as a local application on a computing device, such as the computing device for the content provider 115, and/or provided as a web service such that a content item creator may access the service remotely.

A content item template having an annotation may be received (block 410). For example, the content item template having an annotation may be received by the content item system 220 from the template database 230, from the template developer 210, from the content provider 115, and/or from another source. In some instances, the content item template may be received in response to a selection from a creator of a content item, such as the content provider 115. For example, as noted above, in some instances a content provider 115 may select an icon, link, image, and/or other representation of a content item template on a resource, such as a web page, having one or more content item templates. Such a resource may be associated with the content item system 220 such that content item system 220 receives the selection and requests the content item template from the template database 230. Thus, the content item system may receive the content item template having an annotation from the template database 230. In other implementations, the content item template may be received from another source, such as from a template developer 210 and/or from the content provider 115.

A block diagram overview of an example content item template 500 having an annotation 540 that may be received is shown in FIG. 5. In some instances, the content item template 500 may include several sub-parts, such as separate files for classes or functions used by the content item template 500. In the present example, the content item template 500 may include one or more used APIs 510, one or more defined data types 520, one or more instantiated data objects 530, and/or one or more annotations 540. The APIs 510 may include one or more libraries utilized by the content item template 500 for routines, data structures, object classes, and/or variables. An example of such an API 510 being used in the content item template 500 may include “import flash.text.TextField;” that may be used to create display objects for text display and input. As will be discussed below, the APIs used in a content item template 500 may be used to select and/or generate user interface features.

The data types 520 may include a variety of defined data types, such as Boolean data types, numeric data types, composite data types, string data types, abstract data types, etc. The data types 520 that are used in the content item template 500 may be indicative of the types of data values that will be modified and/or selected by a creator of a content item using the user interface features. An example of such data types 520 may include “var navPosition:String” for a string data type or “var images:Array” for a composite array data type.

The instantiated data objects 530 may include a variety of data objects, such as a background color, a background image, data objects created from a custom class, image arrays, navigation features, etc. For example, “var color:String” creates a data object 530 of “color” and “var image:String” creates a data object 530 of “image.” In addition, “var image:ClickableImage=new ClickableImage( )” creates a data object “image” of the class “ClickableImage( )” The data objects 530 that are used in the content item template 500 may be indicative of the type and/or form of user interface features that may be generated for the content item template 500. For example, the data object 530 of “color” may indicate that a color picking user interface feature may be useful. The determination of user interface features will be described in greater detail below.

Annotations 540 may be inserted identifiers for identifying a portion of the content item template 500. In some instances, the annotations may be an independent identifier to support data structures across different domains or different programming languages. One example annotation 540 may be “[Configurable]” to identify all or a portion of the code for the content item template 500 for which user interface features are to be generated. In some implementations, the annotations 540 may include additional information, such as an id name, a type, and/or other information. For example, “[ConfigurableArrayAdd(id=“Images”, type=“com.ads.ClickableImage”)].” In some implementations, several different types of annotations 540 may be used such that the content item system 220 can determine the user interface features based on the type of the annotation 540. For example, the annotation “[ConfigurableUpdate]” may be used to indicate that a configurable portion of the content item template 500 is to be updated as data values are entered and/or selected by a creator when using the user interface feature, as will be described in greater detail below. Of course, other annotations 540 may be used as well, as will be described herein. Still other data may also be included with the content item template 500.

An example of a content item template 500 for an image carousel may be:

```
package com.ads {
  import com.company.ads.studio.layout.design;
  import flash.text.TextField;
  import flash.events.*;
  import flash.display.*;
  import flash.net.*;
  import flash.geom.PerspectiveProjection;
  import flash.geom.Point;
  public class ImageCarousel extends MovieClip {
  [Configurable]
  public var navPosition:String = “left”;
  private var index:Number = 0;
  private var images:Array = [ ];
  private var navs:Array = [ ];
  private var startWidth:Number = 250;
  private var imageWrapper:MovieClip;
  public function ImageCarousel( ) {
    imageWrapper = new MovieClip( );
    addChild(imageWrapper);
  }
  [ConfigurableArrayAdd(id = “Images”, type =
  “com.ads.ClickableImage”)]
  public function addImage(id:String):void {
    var image:ClickableImage = new ClickableImage( );
    design.getInstance( ).register(id, image, “com.ads.ClickableImage”,
this, “com.ads.ImageCarousel”);
    imageWrapper.addChildAt(image, 0);
    images.push(image);
    image.alpha = 0;
    recreateNavs( );
  }
  [ConfigurableUpdate]
  public function recreateNavs( ) {
    for each (var ob:Nav in navs) {
    removeChild(ob);
    }
    navs = [ ];
    for (var i:int = 0; i < images.length ; i++) {
    var nav:Nav = new Nav( );
    nav.labelLeft.text =
      nav.labelRight.text = “” + (i+1);
    nav.y = 360 − images.length * 35 + i * 35;
    nav.x = navPosition.toLowerCase( ) == “right” ? 300 : 0;
    nav.index = i;
    nav.addEventListener(MouseEvent.CLICK, navClick);
    addChild(nav);
    navs.push(nav);
    }
    selectIndex(index);
  }
  private function navClick(event:Event) {
    selectIndex(event.currentTarget.index);
  }
  private function selectIndex(selected:Number) {
    for (var i:int = 0; i < images.length ; i++) {
    navs[i].alpha = i != selected ? .4 : 1;
    images[i].targAlpha = i != selected ? 0 : 1;
    }
  }
  [ConfigurableArrayDispose(id = “Images”)]
  public function cleanup( ):void {
    for each (var image:ClickableImage in images) {
    imageWrapper.removeChild(image);
    }
    images = [ ];
    index = 0;
    recreateNavs( );
  }
  }
}
```

While the foregoing is an example of a content item template 500 written in ActionScript®, it should be understood that other content item templates 500 written in other languages, such as JavaScript®, etc.

Referring back to FIG. 4, a determination of the data types and/or hierarchies of the content item template and the data objects for the content item template may be made (block 420). In some instances the determination may be made through introspection or analysis of the content item template. For example, the content item system 220 may analyze the code of the content item template, such as that of content item template 500, to determine which APIs are used, what data types are defined, what data objects are instantiated, and/or if hierarchies of data types or data objects are present in the content item template. In other instances, the content item template may include a section identifying the data types and/or hierarchies and the data objects for the content item template. For example, a comments section may be used. Of course, other methods for determining the data types and/or hierarchies of the content item template and the data objects for the content item template may be used.

A data tree may be determined for the content item template (block 430). The data tree may be determined based on the APIs used, the data types and/or hierarchies, the data objects, the annotations, and/or other portions of the content item template that are determined (block 420). In some instances, a data tree may be newly generated or, in other instances, the data tree may be expanded or otherwise modified based on the introspection of the content item template.

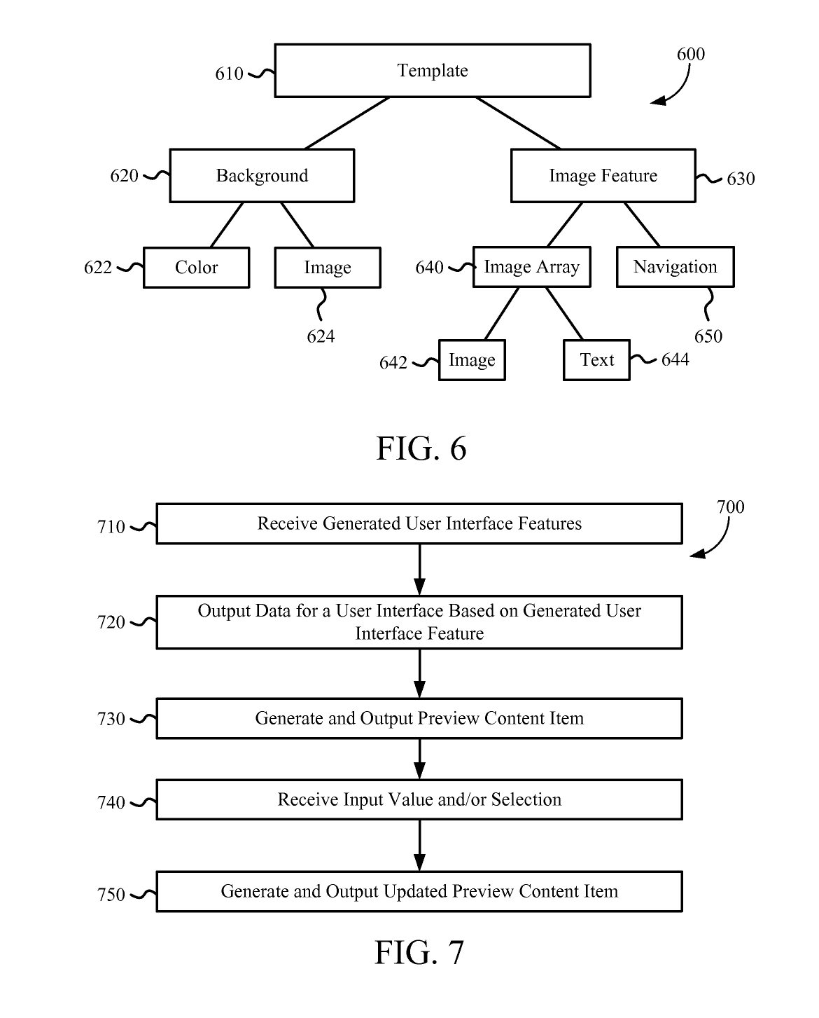

A graphical representation of an example data tree 600 that may be determined from a content item template is shown in FIG. 6. The data tree 600 may include a root template node 610 that may be indicative of the content item template associated with that particular data tree 600. For example, the root template node 610 may include a value, such as an id number or string indicating which content item template the data tree 600 is associated with and/or any other value, and a list of the nodes that extend from the root template node 610. The nodes that extend from the root template node 610 may be determined based on the introspection or determination performed for the content item template (block 420). In the present example, the root template node 610 has child nodes for a background 620 and an image feature 630. Such child nodes may be determined based on the introspection of the content item template including certain data objects, such as “var carousel:ImageCarousel,” from the APIs that are used, and/or otherwise. The background 620 node has further child nodes for a color basic value 622 and an image basic value 624. Such child nodes may be based on the content item template including the data objects associated with the background portion of the content item template, from the APIs that are used, and/or otherwise. In some instances, the background 620 node, the color basic value 622, and the image basic value 624 of the data tree 600 may be included in the data tree 600 independent of the introspection of the content item template. For example, the background 620 node, the color basic value 622, and the image basic value 624 may be included by default in some instances.

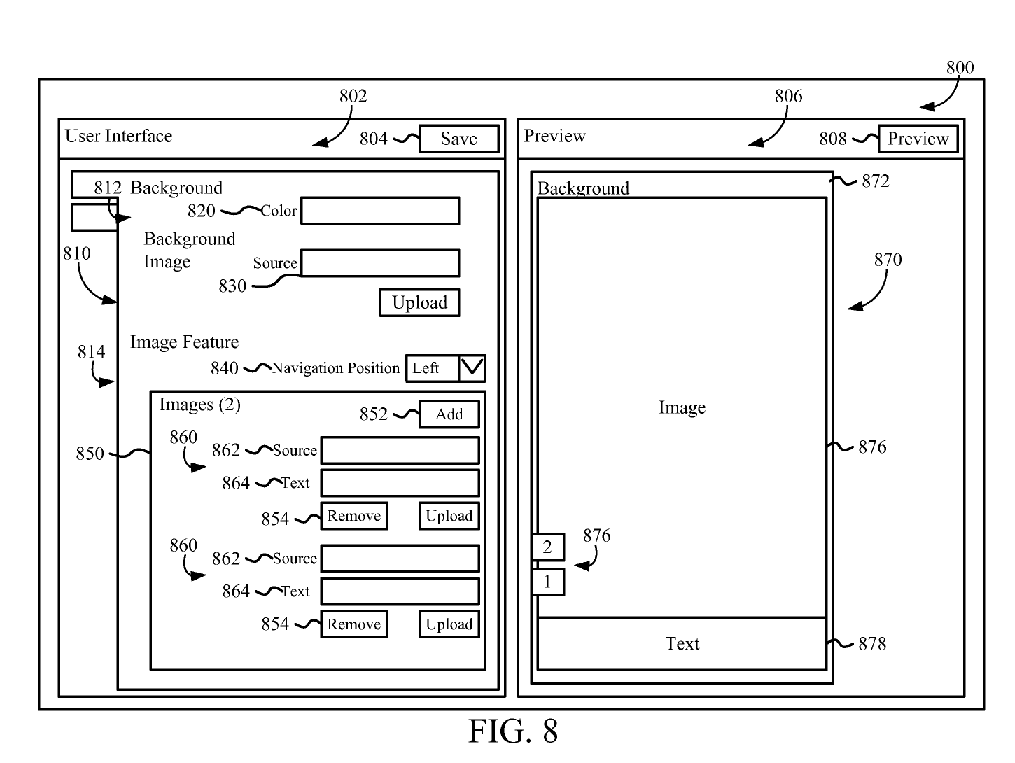

In the present example, the image feature 630 node is an image carousel that includes one or more images that may be cycled through in a sequential manner when the content item is shown. Of course, other features and/or combinations of features may be included in the content item template. The image feature 630 node of the present example includes child nodes for an image array 640 and a navigation portion 650. Such child nodes may be determined based on the content item template including the data objects “var image:ClickableImage=new ClickableImage( )” and “var navPosition:String.” The image array 640 further includes child nodes for an image basic value 642 and a text basic value 644. Such child nodes may be based on the content item template including certain data objects, using certain APIs, and/or otherwise. An example content item that may be generated from the content item template for the data tree 600 is shown as preview content item 870 in FIG. 8. Of course, still other ways of generating data trees and/or data trees having other nodes may be used as well.

The user interface features may be generated by the content item system 220 for the content item template (block 440) based on the determined data tree. For each basic value of the data tree, a base user interface feature may be generated by the content item system 220. For example, a color picking user interface feature may be selected and/or generated for the color basic value 622 of the background 620 node. The color picking user interface feature for the color basic value 622 may be selected and/or generated based on the determined data type, such as a string, and the usage of the data object within the content item template, such as the value of the color data object being used to define a color. In one instance, the base user interface feature for the color basic value may include a text box to specify a data value for the color, such as a hexadecimal value, a name, RGB values, HSB/HSL values, RGBA values, HSBA/HSLA values, and/or otherwise. An example of such a base user interface feature is shown as color picking user interface feature 820 in FIG. 8. In other examples, the color picking user interface feature may include a color wheel, a pop-up window, and/or any other color picking user interface.

In another example, an image selection user interface feature may be selected and/or generated for the image basic value 624 of the background 620 node and/or the image basic value 642 of the image array 640 node. The image selection user interface feature for the image basic value 624, 642 may be selected and/or generated based on the determined data type, such as a string, and the usage of the data object within the content item template, such as the value of the image data object being used to identify a URL address. In an example implementation, the base user interface feature may include both a textbox to designate the source for the image, such as a URL for the image, and a file-select feature to select a file. An example of such a base user interface feature is shown as image selection user interface feature 830 or image selection user interface feature 862. In other examples, the image selection user interface feature may include only a textbox or only a file-select feature. In still further examples, the image selection user interface feature may include a pop-up window and/or other image selection user interface features.

In yet a further example, a position user interface feature may be selected and/or generated for the navigation portion 650 of the image feature 630. The position user interface feature for the navigation portion 650 may be selected and/or generated based on the determined data type, such as a string, and the usage of the data object within the content item template, such as the navigation portion being used to present selectable navigation buttons for the viewer of the content item to optionally select the different images of the image carousel. The base user interface feature may include a drop down box having one or more selectable values that may be used to position the navigation portion. An example of such a base user interface feature is shown as the position user interface feature 840. In other examples, the position user interface feature may include radio buttons, textboxes to enter positional coordinates, and/or other position user interface features.

In still another example, a text user interface feature may be selected and/or generated for the text basic value 644 of the image array 640. The text user interface feature for the text basic value 644 may be selected and/or generated based on the determined data type, such as a string, and the usage of the data object within the content item template, such as the text being displayed with the images of an image array. The base user interface feature may include a text box for entry of a textual input. An example of such a base user interface feature is shown as text user interface feature 864. Of course, still other base user interface features may be selected and/or generated based on the introspection of the data for the content item template.

For each appendable value of the data tree, such as an array, an appendable user interface feature may be selected and/or generated. For example, an appendable array user interface feature may be selected and/or generated for the image array 640 of the image feature 630. The appendable user interface feature may include “Add”/“Remove” buttons, such as buttons 852, 854, to add or remove images from the image array. In some implementations, the appendable user interface feature may include a drop-down box with numbers to specify the number of items in the array or may include features. In still other implementations, the appendable user interface feature may be combined with other user interface features, such as the base user interface features described herein.

For each composite value of the data tree, user interface features may be selected and/or generated for each member value of the composite value of the data tree to form a composite user interface feature. In the example shown in FIG. 6, the image array 640 is both an appendable value and a composite value having member values of an image basic value 642 and a text basic value 644. A base user interface feature may be generated for each image basic value 642, such as those shown as image user interface features 862 of FIG. 8. A base user interface feature may also be generated for each text basic value 644, such as that shown as text user interface feature 864. The composite user interface feature may include both the image user interface feature and the text user interface feature in this example.

In some implementations, the user interface features may be generated for every basic value, composite value, and/or appendable value of the data tree. For instance, using data tree 600 as an example, the user interface features for the color picking user interface, the image selection user interface, the position user interface feature, and the appendable and composite user interface feature for the image array having an image selection user interface and a text user interface feature may be generated. In other instances, the user interface features may be generated for only those basic values, composite values, and/or appendable values of the data tree 600 associated with an annotation of the content item template. For instance, user interface features may be generated only for those portions of the data tree that have the annotation “[Configurable]” associated. Thus, user interface features may not be generated for portions of the template that are not associated with an annotation.

Once the user interface features have been generated, the data for the generated user interface features for customizing the content item template may be saved, in some instances. For example, a configuration file may be generated based on the generated user interface features and may be associated with the content item template such that, when the content item template is selected to be customized, the configuration file may be used to generate a user interface based on the determined and/or generated user interface features from method 400. In other instances, the data for the generated user interface features for customizing the content item template may be appended and/or prepended to the content item template. For example, data for the various user interface features generated based on the introspection of the content item template may be prepended to the beginning of the content item template such that a user interface may be generated from the prepended portion of the content item template. Of course, other methods of storing the data for the generated user interface features may be used as well.

In some implementations, the generation of the user interface features may be performed when a content item template is received. For instance, when a template developer 210 uploads or submits a template to the content item system 220. The content item system 220 may determine the data types and data objects of the template, determine a data tree based on the determined data types and data objects, generate the user interface features for the content item template, and store the data for the generated user interface features, such as in a user interface configuration file, as part of the content item template, etc. In other instances, the generation of the user interface features for the content item template may occur at any other time. For example, on demand or when the content item system 220 is not being used for other purposes. In some implementations, a creator of the content item template may override the generated user interface features and manually select a user interface feature.

In some implementations, the data for the generated user interface features may be used to populate a user interface template. In some instances, the populated user interface template having the generated user interface features may be output to the creator of the content item template. In such an instance, the creator of the content item template, such as a template developer 210, may modify the populated user interface template and/or the generated user interface features. For example, the automatic generation of the user interface feature for a customizable portion of the content item template may not match what the creator of the template would prefer for the user interface. In such a case, the creator of the content item template may modify the generated user interface feature, select a different user interface feature, and/or otherwise adjust the user interface features. In some instances, a tuning algorithm may be applied to the populated user interface and/or the generated user interface features to modify the appearance, layout, and/or otherwise optimize the populated user interface and/or the generated user interface features. In some versions, the generated user interface features and/or the populated user interface template may be visually arranged according to the structure of the data tree. For example, as shown in FIG. 8, the user interface 810 is visually arranged to have indented regions corresponding to the structure of the data tree 600. In still other versions, the data tree may be used as the user interface template and the generated user interface features may be associated with the corresponding portions of the data tree (e.g., as the value of the node of the data tree) such that the data tree may be used to generate a user interface.

Referring to FIG. 7, a method 700 for providing a user interface, presenting a preview content item, and generating an updated preview content item is shown. In some implementations, the method 700 may be performed in response to a selection of a content item template. As noted above, the content item template may be stored in the template database 230 of a content item system 220. Several templates may be stored on the template database 230 such that a creator of a content item may have a variety of templates to select from. The selection of the content item template may be performed by selecting an icon, link, image, and/or other representation of the content item template on a resource, such as a web page, having one or more content item templates. In other instances, the selection of the content item template may be performed by selecting a file, either locally stored or remotely stored, for the content item template.

The generated user interface features for the content item template may be received (block 710). In some instances, the content item system 220 may receive the generated user interface features via a configuration file, via a content item template having data for the user interface features prepended and/or appended, and/or otherwise. In some implementations, the content item system 220 may receive the generated user interface features may occur after the generation of the user interface features for the content item template (block 440). In other instances, the receiving of the generated user interface features may occur at another time. For instance, if the user interface features were generated and stored when the content item template was initially received by the content item system 220, the content item system 220 may receive the generated user interface features (block 710) at a later time, such as when a creator of a content item selects the template for use in the creation of a content item based on the content item template.

Data to effect presentation of a user interface based on the generated user interface features may be outputted (block 720). For instance, a user interface template may be populated with the generated user interface features for a selected content item template and data to effect presentation of the user interface may be outputted or otherwise sent by the content item system 220 to a computing device, such as that of a creator of a content item. In some instances, a tuning algorithm may be applied to the populated user interface and/or the generated user interface features to modify the appearance, layout, and/or otherwise optimize the populated user interface and/or the generated user interface features. The outputted data to effect presentation of the user interface may be arranged such that the visual arrangement of the user interface substantially corresponds with the structure of the data tree for the content item template. In some instances, the user interface may be a part of a remote web service via a web page, such as the user interface 810 of web page 800 of FIG. 8, or the user interface may be part of a local application.

A preview content item may be generated and outputted (block 730) by the content item system 220. For example, the content item system 220 may generate the preview content item based on the content item template and one or more values entered and/or selected for the various user interface features. In some instances, the content item system 220 may generate and output an initial preview content item using temporary or default values and/or selections. These temporary values and/or selections may be inserted into the customizable portions of the content item template to generate an initial preview content item. The content item system 220 may output both the initial preview image and the user interface at substantially the same time. In other instances, the preview content item may not be displayed until values and/or selections are provided via the user interface.

An input value and/or selection may be received (block 740) by the content item system 220. For example, a creator of a content item utilizing the user interface constructed using the generated user interface features may select a user interface feature and provide an input value and/or selection (e.g., entering a number or text, selecting an item from a list or dropdown menu, etc.). The input value and/or selection may be received from a computing device of the creator of the content item as the creator is entering the value and/or selection into the user interface features (e.g., as the user types in text into a textbox, the characters entered into the textbox may be transmitted). In other instances, the input value and/or selection may be received in response to another user interaction, such as selecting a button (e.g., a “Save” or “Preview” button). Of course still other ways of receiving an input value and/or selection may be provided.

In some instances, an updated preview content item may be generated and outputted (block 750). In one example implementation, the updated preview content item may be generated and outputted as values and/or selections are changed for the various user interface features of the user interface. A data binding API may be used to determine if a corresponding value and/or selection of a user interface feature is change, and the new value and/or selection may be used with the content item template to generate an updated preview content item based on the new value. In some instances, the data binding API may determine if a change to the value and/or selection occurs for each user interface feature and/or the data binding API may only determine if a change to the value and/or selection occurs for certain annotated user interface features. For example, the user interface features for which the live updating may be applied may be indicated by a specific annotation, such as “[ConfigurableUpdate].” When the value and/or selection is changed for the annotated user interface features, the preview content item may be updated to reflect the changed value by generating and outputting an updated preview content item by using the values and/or selections, including the updated value and/or selection, with the content item template. In other implementations, the updated preview content item may be generated and outputted in response to a user interaction, such as via a selection of a “Preview” button. Accordingly, the updated preview content item may be generated on demand rather than automatically. Of course, other ways to generate an updated preview content item may be implemented as well.

An example preview content item 870 and a corresponding example user interface 810 are shown in FIG. 8. In the present example, the preview content item 870 and the user interface 810 are provided as part of a web service of a web page 800 for generating content items from content item templates by customizing the content item using the user interface 810. In the example shown, the web page 800 includes a user interface portion 802 and a preview portion 806. The user interface portion 802 includes a user interface 810 and a “Save” button 804. The “Save” button 804 may be configured to generate and output a content item based on the selected content item template and the values entered and/or selected for the various user interface features of the user interface 810. In some instances, the “Save” button 804 may be used to temporarily save the values entered and/or selected for the various user interface features for later editing and/or customization.

In the present example, the user interface 810 is generated based on the example content item template used to create data tree 600. The user interface 810 includes a background portion 812 and an image feature portion 814, corresponding to the background 620 node and the image feature 630 node. The background portion 812 includes the generated user interface features of a color picking user interface feature 820 to select a background color and an image selection user interface feature 830 to provide an image as the background image. The color picking user interface feature 820 and the image selection user interface feature 830 correspond to the color basic value 622 and the image basic value 624 of the background 620 node. Such user interface features may be generated through the introspection described above in reference to FIG. 4.

The image feature portion 814 includes the generated user interface features for a position user interface feature 840 to select a position for a navigational feature and an image array user interface feature 850 for adding images to an image array for an image carousel. The position user interface feature 840 corresponds to the navigation portion 650 of the data tree 600. The image array user interface feature 850 is an appendable and composite user interface feature based on the appendable and composite image array 640 of the data tree 600. In the example shown, the image array user interface feature 850 includes two members 860 for each image of the image array. Each member 860 includes an image selection user interface feature 862, a text user interface feature 864, and a “Remove” button 854 to remove the member 860 from the image array user interface feature 850. The image selection user interface feature 862 and the text user interface feature 864 correspond to the image basic value 642 and the text basic value 644 of the image array 640 of data tree 600. The “Remove” button 854 is based on the image array 640 being an appendable value for data tree 600. Selection of the “Remove” button 854 removes the corresponding member 860. The image array user interface feature 850 also includes an “Add” button 852 to add an image for the image array. Selection of the “Add” button 852 will add a member 860, which includes a new image selection user interface feature 862, a new text user interface feature 864, and a new “Remove” button 854. Thus, it should be understood that multiple members 860 may be added and/or removed and the image selection user interface feature 862, the text user interface feature 864, and the “Remove” button 854 may be added and/or removed from the user interface 810. Of course, other user interfaces 810 may be generated from data trees and other user interface features as well.

The preview portion 806 includes a “Preview” button 808 and a preview content item 870. In some implementations, an initial preview content item 870 may be generated based on the selected content item template and one or more temporary or default values for the various user interface features of the user interface 810. For example, content item system 220 may include temporary values when a content item template is selected and/or a template developer 210 may include temporary or example values when creating the content item template. In some instances, the preview content item 870 may not be generated until values are entered and/or selected for the various user interface features of the user interface 810. In still further implementations, the preview content item 870 may be generated only when the “Preview” button 808 is selected.

The preview content item 870 of the present example is a preview of a content item based on the values entered and/or selected for the various user interface features of the user interface 810 and based on the content item template. In the present example, the preview content item includes a background 872, an image 874, a navigation feature 876, and text 878. The background 872 may include a color selected using the color picking user interface feature 820 and/or an image using the image selection user interface feature 830. In one example, when the color picking user interface feature 820 is selected (e.g., a user clicks on the textbox to input a value for the color, such as a hexadecimal value) the background 872 of the preview content item 870 may be highlighted or otherwise indicated (e.g., bold outline, etc.). Thus, display data to effect display of the preview content item 870 having a highlighted portion corresponding to the background 872 may be outputted. If, in some instances, the background color portion of the content item template has an annotation that is indicative of an updatable portion of the content item template, such as “[ConfigurableUpdate],” then the color of the background 872 may automatically update as the color is entered into the textbox of the color picking user interface feature 820. As noted above, a data binding API may be used to determine if the value of the textbox has changed and, if so, the new value may be used with the content item template to generate an updated preview content item 870 based on the new value. In other instances, the preview content item 870 may not be updated until the “Preview” button 808 is selected.

Similarly, when the image selection user interface feature 830 is selected (e.g., a user clicks on the textbox to input a source for the image, such as a URL or a local file path) the background 872 or an image of the background 872 of the preview content item 870 may be highlighted or otherwise indicated (e.g., bold outline, etc.). Thus, display data to effect display of the preview content item 870 having a highlighted portion corresponding to the background 872 may be outputted. If, in some instances, the background image portion of the content item template has an annotation that is indicative of an updatable portion of the content item template, such as “[ConfigurableUpdate],” then the image of the background 872 may automatically update when the image source is entered into the textbox of the image selection user interface feature 830. In other instances, the image may need to be uploaded prior to the preview content item 870 being updated, such as by selection an “Upload” button associated with the image selection user interface feature 830. As noted above, a data binding API may be used to determine if the value of the textbox has changed and, if so, the new value may be used with the content item template to generate an updated preview content item 870 based on the new value. In other instances, the preview content item 870 may not be updated until the “Preview” button 808 is selected.

The navigation feature 876 may include a position selected (e.g., left, right, top, bottom, etc.) using the position user interface feature 840. In one example, when the position user interface feature 840 is selected (e.g., a user clicks on the dropdown menu to select a selection for the position of the navigational controls or buttons) the navigation feature 876 of the preview content item 870 may be highlighted or otherwise indicated (e.g., bold outline, etc.). Thus, display data to effect display of the preview content item 870 having a highlighted portion corresponding to the navigation feature 876 may be outputted. If, in some instances, the navigation portion of the content item template has an annotation that is indicative of an updatable portion of the content item template, such as “[ConfigurableUpdate],” then the navigation feature 876 may automatically update based on the selected position using the position user interface feature 840 and/or based on other input values or selections. For example, because the navigation feature 876 includes a navigation button for each image of the image array, the navigation feature 876 may also be updated based on the addition or removal of an image from the image array. As noted above, a data binding API may be used to determine if the value or selection for the position selection as well as the number of images in the image array have change and, if so, the new value may be used with the content item template to generate an updated preview content item 870 based on the new value. In other instances, the preview content item 870 may not be updated until the “Preview” button 808 is selected.

The image 874 may include an image selected using the image selection user interface feature 862 of the image array user interface feature 850. In one example, when the image selection user interface feature 862 is selected (e.g., a user clicks on the source textbox to input a source for the image, such as a URL or a local file path) the image 874 of the preview content item 870 may be highlighted or otherwise indicated (e.g., bold outline, etc.). Thus, display data to effect display of the preview content item 870 having a highlighted portion corresponding to the image 874 may be outputted. If, in some instances, the image array of the content item template has an annotation that is indicative of an updatable portion of the content item template, such as “[ConfigurableUpdate],” then the image 874 may automatically update when the image source is entered into the textbox of the image selection user interface feature 862. In other instances, the image 874 may need to be uploaded prior to the preview content item 870 being updated, such as by selection an “Upload” button associated with the image selection user interface feature 862. As noted above, a data binding API may be used to determine if the value of the textbox has changed and, if so, the new value may be used with the content item template to generate an updated preview content item 870 based on the new value. In other instances, the preview content item 870 may not be updated until the “Preview” button 808 is selected.

The text 878 may include inputted text using the text user interface feature 864 of the image array user interface feature 850. In one example, when the text user interface feature 864 is selected (e.g., a user clicks on the text textbox to input text) the text 876 of the preview content item 870 may be highlighted or otherwise indicated (e.g., bold outline, etc.). Thus, display data to effect display of the preview content item 870 having a highlighted portion corresponding to the text 878 may be outputted. If, in some instances, the image array of the content item template has an annotation that is indicative of an updatable portion of the content item template, such as “[ConfigurableUpdate],” then the text 878 may automatically update when text is entered into the textbox of the text user interface feature 864. As noted above, a data binding API may be used to determine if the value of the textbox has changed and, if so, the new value may be used with the content item template to generate an updated preview content item 870 based on the new value. In other instances, the preview content item 870 may not be updated until the “Preview” button 808 is selected.

In some instances, the content item template may be a template for a rich media content item, such as an image carousel described herein. Such content items may include several frames such that portions of the generated content item (e.g., some of the images from the image array) are not necessarily shown with other portions of the content item. For example, for an image carousel with two images 874, one image 874 may be shown for a predetermined period of time and then a second image 874 is shown for a second predetermined period of time. The images 874 may continue to rotate while the content item is shown. Accordingly, when creating the content item from a content item template, it may be useful to be able to preview each image 874 using the preview content item 870. Thus, in some implementations, a frame selection feature may be included with the user interface 810 (e.g., a drop down menu, etc.) or the frame selection feature may be incorporated into a user interface feature, such as the image array user interface feature 850. By way of example only, selection of the first member 860 of the image array user interface feature 850 (e.g., selection of the textbox for the image selection user interface feature 862 and/or the textbox for the text user interface feature 864) may cause the preview content item 870 to be updated to show the selected frame, such as the corresponding image 874 and text 878. Thus, data may be outputted to effect presentation of the selected frame of the preview content item 870 based on the received frame selection.

Of course, it should be understood that other content items, other content item templates, other generated user interface features, and/or preview content items may be used, generated, and/or implemented as well.

In some implementations, a key-value structure may be implemented to define the customizable portions of the content item template. For example, a placeholder value may be inserted into the content item template where customizable values will be used and a key-value structure may be used to define the customizable data.

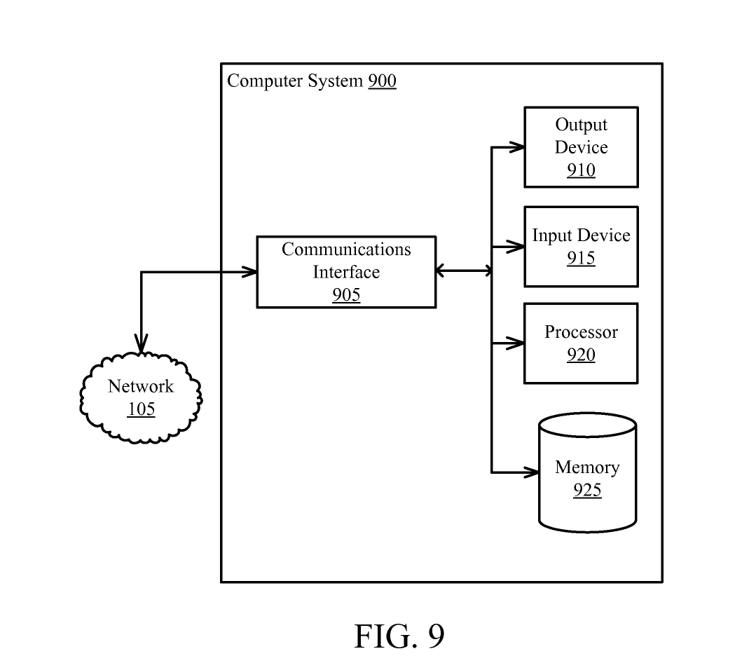

FIG. 9 shows the general architecture of an illustrative computer system 900 that may be employed to implement any of the methods or systems discussed herein in accordance with some implementations. In some instances, multiple computer systems 900 may be used for one or more aspects of system 100 described herein. The computer system 900 may be used to provide information via network 105. The computer system 900 comprises one or more processors 920 communicatively coupled to memory 925, one or more communications interfaces 905, one or more output devices 910 (e.g., one or more display units), and one or more input devices 915. The processors 920 may be included as part of the data processing system 110, the content placement system 130, the resource server 120, the requesting device 125, the content provider 115, the content item system 220, and/or the template developer 210.

In the computer system 900, the memory 925 may comprise any computer-readable storage media, and may store computer instructions such as processor-executable instructions for implementing the various functionalities described herein for respective systems, as well as any data relating thereto, generated thereby, or received via the communications interface(s) or input device(s) (if present). The processor(s) 920 may be used to execute instructions stored in the memory 925 and, in so doing, also may read from or write to the memory various information processed and or generated pursuant to execution of the instructions.

The processor 920 of the computer system 900 also may be communicatively coupled to or control the communications interface(s) 905 to transmit or receive various information pursuant to execution of instructions. For example, the communications interface(s) 905 may be coupled to a wired or wireless network, bus, or other communication means and may therefore allow the computer system 900 to transmit information to and/or receive information from other devices (e.g., other computer systems).

The output devices 910 of the computer system 900 may be provided, for example, to allow various information to be viewed or otherwise perceived in connection with execution of the instructions. The input device(s) 915 may be provided, for example, to allow a user to make manual adjustments, make selections, enter data or various other information, or interact in any of a variety of manners with the processor during execution of the instructions. Additional information relating to a general computer system architecture that may be employed for various systems discussed herein is provided at the conclusion of this disclosure.

Implementations of the subject matter and the operations described in this specification can be implemented in digital electronic circuitry, or in computer software embodied on a tangible medium, firmware, or hardware, including the structures disclosed in this specification and their structural equivalents, or in combinations of one or more of them. Implementations of the subject matter described in this specification can be implemented as one or more computer programs, i.e., one or more modules of computer program instructions, encoded on computer storage medium for execution by, or to control the operation of, data processing apparatus. A computer storage medium can be, or be included in, a computer-readable storage device, a computer-readable storage substrate, a random or serial access memory array or device, or a combination of one or more of them. Moreover, while a computer storage medium is not a propagated signal, a computer storage medium can be a source or destination of computer program instructions encoded in an artificially-generated propagated signal. The computer storage medium can also be, or be included in, one or more separate physical components or media (e.g., multiple CDs, disks, or other storage devices).

The term “data processing apparatus,” “data processing system,” or “computing device” encompasses all kinds of apparatus, devices, and machines for processing data, including by way of example a programmable processor, a computer, a system on a chip, or multiple ones, or combinations, of the foregoing. The apparatus can include special purpose logic circuitry, e.g., an FPGA (field programmable gate array) or an ASIC (application-specific integrated circuit). The apparatus can also include, in addition to hardware, code that creates an execution environment for the computer program in question, e.g., code that constitutes processor firmware, a protocol stack, a database management system, an operating system, a cross-platform runtime environment, a virtual machine, or a combination of one or more of them. The apparatus and execution environment can realize various different computing model infrastructures, such as web services, distributed computing and grid computing infrastructures.

A computer program (also known as a program, software, software application, script, or code) can be written in any form of programming language, including compiled or interpreted languages, declarative or procedural languages, and it can be deployed in any form, including as a stand-alone program or as a module, component, subroutine, object, or other unit suitable for use in a computing environment. A computer program may, but need not, correspond to a file in a file system. A program can be stored in a portion of a file that holds other programs or data (e.g., one or more scripts stored in a markup language document), in a single file dedicated to the program in question, or in multiple coordinated files (e.g., files that store one or more modules, sub-programs, or portions of code). A computer program can be deployed to be executed on one computer or on multiple computers that are located at one site or distributed across multiple sites and interconnected by a communication network.

Processors suitable for the execution of a computer program include, by way of example, both general and special purpose microprocessors, and any one or more processors of any kind of digital computer. Generally, a processor will receive instructions and data from a read-only memory or a random access memory or both. The essential elements of a computer are a processor for performing actions in accordance with instructions and one or more memory devices for storing instructions and data. Generally, a computer will also include, or be operatively coupled to receive data from or transfer data to, or both, one or more mass storage devices for storing data, e.g., magnetic, magneto-optical disks, or optical disks. However, a computer need not have such devices. Moreover, a computer can be embedded in another device, e.g., a mobile telephone, a personal digital assistant (PDA), a mobile audio or video player, a game console, a Global Positioning System (GPS) receiver, or a portable storage device (e.g., a universal serial bus (USB) flash drive), for example. Devices suitable for storing computer program instructions and data include all forms of non-volatile memory, media and memory devices, including by way of example semiconductor memory devices, e.g., EPROM, EEPROM, and flash memory devices; magnetic disks, e.g., internal hard disks or removable disks; magneto-optical disks; and CD-ROM and DVD-ROM disks. The processor and the memory can be supplemented by, or incorporated in, special purpose logic circuitry.

To provide for interaction with a user, implementations of the subject matter described in this specification can be implemented on a computer having a display device, e.g., a CRT (cathode ray tube), plasma, or LCD (liquid crystal display) monitor, for displaying information to the user and a keyboard and a pointing device, e.g., a mouse or a trackball, by which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input. In addition, a computer can interact with a user by sending documents to and receiving documents from a device that is used by the user; for example, by sending web pages to a web browser on a user's client device in response to requests received from the web browser.

Implementations of the subject matter described in this specification can be implemented in a computing system that includes a back-end component, e.g., as a data server, or that includes a middleware component, e.g., an application server, or that includes a front-end component, e.g., a client computer having a graphical user interface or a Web browser through which a user can interact with an implementation of the subject matter described in this specification, or any combination of one or more such back-end, middleware, or front-end components. The components of the system can be interconnected by any form or medium of digital data communication, e.g., a communication network. Examples of communication networks include a local area network (“LAN”) and a wide area network (“WAN”), an inter-network (e.g., the Internet), and peer-to-peer networks (e.g., ad hoc peer-to-peer networks).

The computing system can include clients and servers. A client and server are generally remote from each other and typically interact through a communication network. The relationship of client and server arises by virtue of computer programs running on the respective computers and having a client-server relationship to each other. In some implementations, a server transmits data (e.g., an HTML page) to a client device (e.g., for purposes of displaying data to and receiving user input from a user interacting with the client device). Data generated at the client device (e.g., a result of the user interaction) can be received from the client device at the server.

While this specification contains many specific implementation details, these should not be construed as limitations on the scope of any inventions or of what may be claimed, but rather as descriptions of features specific to particular implementations of the systems and methods described herein. Certain features that are described in this specification in the context of separate implementations can also be implemented in combination in a single implementation. Conversely, various features that are described in the context of a single implementation can also be implemented in multiple implementations separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. In some cases, the actions recited in the claims can be performed in a different order and still achieve desirable results. In addition, the processes depicted in the accompanying figures do not necessarily require the particular order shown, or sequential order, to achieve desirable results.

In certain circumstances, multitasking and parallel processing may be advantageous. Moreover, the separation of various system components in the implementations described above should not be understood as requiring such separation in all implementations, and it should be understood that the described program components and systems can generally be integrated together in a single software product embodied on a tangible medium or packaged into multiple such software products.

The phraseology and terminology used herein is for the purpose of description and should not be regarded as limiting. The use of “including” “comprising” “having” “containing” “involving” “characterized by” “characterized in that” and variations thereof herein, is meant to encompass the items listed thereafter, equivalents thereof, and additional items, as well as alternate implementations consisting of the items listed thereafter exclusively. In one implementation, the systems and methods described herein consist of one, each combination of more than one, or all of the described elements, acts, or components.

Any references to implementations or elements or acts of the systems and methods herein referred to in the singular may also embrace implementations including several of these elements, and any references in plural to any implementation or element or act herein may also embrace implementations including only a single element. References in the singular or plural form are not intended to limit the presently disclosed systems or methods, their components, acts, or elements to single or plural configurations. References to any act or element being based on any information, act or element may include implementations where the act or element is based at least in part on any information, act, or element.

Any implementation disclosed herein may be combined with any other implementation or embodiment, and references to “an implementation,” “some implementation,” “an alternate implementation,” “various implementation,” “one implementation” or the like are not necessarily mutually exclusive and are intended to indicate that a particular feature, structure, or characteristic described in connection with the implementation may be included in at least one implementation or embodiment. Such terms as used herein are not necessarily all referring to the same implementation. Any implementation may be combined with any other implementation, inclusively or exclusively, in any manner consistent with the aspects and implementations disclosed herein.

References to “or” may be construed as inclusive so that any terms described using “or” may indicate any of a single, more than one, and all of the described terms.

Where technical features in the drawings, detailed description or any claim are followed by reference signs, the reference signs have been included for the sole purpose of increasing the intelligibility of the drawings, detailed description, and claims. Accordingly, neither the reference signs nor their absence have any limiting effect on the scope of any claim elements.

The systems and methods described herein may be embodied in other specific forms without departing from the characteristics thereof. The foregoing implementations are illustrative rather than limiting of the described systems and methods. Scope of the systems and methods described herein is thus indicated by the appended claims, rather than the foregoing description, and changes that come within the meaning and range of equivalency of the claims are embraced therein.

What is claimed is:

1. A method for generating a user interface comprising:
receiving, at a data processor, a template for creating a content item, wherein the template comprises an annotation;
determining, using the data processor, a plurality of data types of the received template and a plurality of data objects of the received template;
determining, using the data processor, a data tree based on the determined plurality of data types and the determined plurality of data objects;
generating, using the data processor, a user interface feature for the template based on the data tree and the annotation, wherein the user interface feature comprises:
a base user interface feature for a basic value of the data tree, and
an appendable user interface feature for an appendable value of the data tree; and
outputting data to effect presentation of a user interface based on the generated user interface feature.

2. The method of claim 1, wherein the user interface feature further comprises:
a composite user interface feature for a composite value of the data tree.

3. The method of claim 2, wherein the composite value comprises a plurality of member values, wherein the user interface feature further comprises a member user interface feature for each member value of the plurality of member values.

4. The method of claim 1, further comprising:
applying a tuning algorithm to the generated user interface feature or the outputted data to effect presentation of the user interface.

5. The method of claim 1, further comprising:
outputting data to effect presentation of the user interface, wherein the user interface is visually arranged according to a structure of the determined data tree.

6. The method of claim 1, wherein the annotation is indicative of an updatable portion of the template.

7. The method of claim 1, further comprising:
determining, using the data processor, an application programming interface of the template;
wherein the step of generating a user interface feature for the template is further based on the determined application programming interface.

8. The method of claim 1, further comprising:
storing, in a database, a configuration file for the user interface feature.

9. The method of claim 1, further comprising:
adding configuration data to the template for the user interface feature.

10. A system comprising:
a data processor; and
a computer readable storage device storing instructions that, when executed by the data processor, cause the data processor to perform operations comprising:
receiving a template for creating a content item, wherein the template comprises an annotation,
determining a plurality of data types of the received template and a plurality of data objects of the received template,
generating a user interface feature for the template based on the annotation and at least one of a data type of the plurality of data types or a data object of the plurality of data objects, and,
outputting data to effect presentation of a user interface based on the generated user interface feature,
receiving an input associated with a data object of the plurality of data objects, and
outputting data to effect presentation of a preview content item based on the received input and the template.

11. The system of claim 10, wherein the computer readable storage device storing instructions that, when executed by the data processor, cause the data processor to perform operations further comprising:
receiving a selection associated with a data object of the plurality of data objects, and
outputting data to effect presentation of a highlight of a portion of the preview content item associated with the data object.

12. The system of claim 10, wherein the content item comprises a rich media content item, wherein the user interface comprises a frame selection feature.

13. The system of claim 12, wherein the computer readable storage device storing instructions that, when executed by the data processor, cause the data processor to perform operations further comprising:
receiving a frame selection via the frame selection feature, and
outputting data to effect presentation of a frame of the preview content item based on the received frame selection.

14. The system of claim 10, wherein the computer readable storage device storing instructions that, when executed by the data processor, cause the data processor to perform operations further comprising:
determining a data tree based on the plurality of data types and the plurality of data objects;
wherein the user interface feature comprises:
a base user interface feature for a basic value of the data tree,
an appendable user interface feature for an appendable value of the data tree, and
a composite user interface feature for a composite value of the data tree.

15. The system of claim 14, wherein the user interface is visually arranged according to the data tree.

16. The system of claim 10, wherein the user interface feature is further based on an application programming interface of the template.

17. A computer readable storage device having instructions to provide information via a computer network, the instructions comprising instructions to:
receive a template for creating a content item, wherein the template comprises an annotation;
determine a plurality of data types of the received template and a plurality of data objects of the received template;
determine a data tree for the template based on the plurality of data types and the plurality of data objects; and
generate a user interface feature for the template based on the data tree and the annotation, wherein the user interface feature comprises:
a base user interface feature for a basic value of the data tree,
an appendable user interface feature for an appendable value of the data tree, and
a composite user interface feature for a composite value of the data tree.

18. The computer readable storage device of claim 17, wherein the instructions further comprise instructions to:
output data to effect presentation of a user interface based on the generated user interface feature; and
output data to effect presentation of a preview content item based on the template.

19. The computer readable storage device of claim 18, wherein the instructions further comprise instructions to:
receive an input associated with a data object of the plurality of data objects, and
output data to effect presentation of an updated preview content item based on the received input and the template.

20. The computer readable storage device of claim 18, wherein the instructions further comprise instructions to:
receive a selection associated with a data object of the plurality of data objects, and
output data to effect presentation of a highlight of a portion of the preview content item associated with the selected data object.
